(19) United States
(12) Patent Application Publication
(10) Pub. No.: US 2026/0229053 A1
(43) Pub. Date: Aug. 6, 2026

(54) MACHINE-LEARNING ENHANCED INVOICE DATA EXTRACTION

(71) Applicant: NCR Voyix Corporation, Atlanta, GA (US)

(72) Inventors: Eric Smith, Atlanta, GA (US); Kyle Daniel Wade, Dallas, TX (US); Mihir Shrirang Joshi, Atlanta, GA (US); Sergey Gavrilov, Atlanta, GA (US)

(21) Appl. No.: 19/042,960

(22) Filed: Jan. 31, 2025

(51) Int. Cl. G06V 30/19; G06V 30/16; G06V 30/413; G06V 30/414

(52) U.S. Cl. CPC G06V 30/19133; G06V 30/16; G06V 30/19127; G06V 30/19173; G06V 30/413; G06V 30/414

(57) ABSTRACT

Methods and a system for processing invoices that combine multiple optical character recognition (OCR) algorithms with machine learning classification to automate invoice data extraction and validation. Both digital and physical invoice uploads are processed, image preprocessing is performed, and specialized OCR algorithms are processed to extract text and create bounding boxes around invoice elements. An intelligent classification engine employs customizable heuristics and machine learning to map extracted text to invoice fields, while maintaining a database of known vendors and items to improve accuracy. An interactive review interface is provided where users can validate and adjust recognized elements, with all corrections being stored to enable continuous system learning. Upon validation, the processed invoice data seamlessly integrates with existing restaurant management systems, providing an efficient solution for automated invoice processing.

### BACKGROUND

In the restaurant industry, invoice processing remains a significant operational challenge that impacts efficiency and accuracy. Restaurant operators must handle large volumes of invoices from multiple vendors, with each invoice potentially containing dozens of line items that need to be carefully reviewed and entered into their management systems. The manual entry of invoice data is time-consuming and prone to human error, particularly when dealing with physical paper invoices that may have varying formats, poor image quality, or handwritten modifications. Additionally, the task of correctly identifying and mapping invoice elements such as vendor information, item codes, quantities, and prices requires considerable time and attention to detail from staff members who could otherwise focus on more value-adding activities. The complexity increases when restaurants need to maintain accurate records for inventory management, cost tracking, and accounting purposes, while also dealing with time-sensitive information that affects their daily operations.

### BRIEF DESCRIPTION OF THE DRAWINGS

FIG. 1A is a diagram of a system machine-learning enhanced invoice data extraction, according to an example embodiment.

FIG. 1B is a flow diagram of a method for classifying column types, according to an example embodiment.

FIG. 2 is a flow diagram of a method for performing machine-learning enhanced invoice data extraction, according to an example embodiment.

FIG. 3 is a flow diagram of another method for performing machine-learning enhanced invoice data extraction, according to an example embodiment.

### DETAILED DESCRIPTION

Existing invoice processing techniques face several challenges in the restaurant industry context. Current optical character recognition (OCR) solutions often struggle with varying invoice formats and layouts, leading to inconsistent text recognition and mapping of invoice elements. The use of a single OCR algorithm results in reduced accuracy, particularly when dealing with poor quality scans or images from mobile devices. Additionally, conventional systems lack the ability to leverage historical data and known vendor information, requiring manual verification and correction of each processed invoice. The challenge is further complicated by the presence of handwritten modifications and notes on invoices, which traditional OCR systems struggle to handle effectively. Current solutions also typically process invoices in a rigid, linear fashion without allowing for user intervention during the recognition process, leading to increased processing time when errors need to be corrected.

In embodiments described herein, a multi-layered approach to invoice processing combines multiple specialized OCR algorithms to optimize text recognition based on specific use cases. The methods and systems that follow employ different algorithms for processing individual cells versus entire documents, selecting the most effective recognition method for each scenario. The teachings herein implement a sophisticated classification engine that utilizes both predefined heuristics and machine learning capabilities to accurately map recognized text to appropriate invoice fields, thereby providing a technical solution to the technical problems noted above with respect to existing invoice processing techniques.

The methods and system described herein also incorporate an interactive review mechanism that presents users with visual annotations of recognized elements, enabling real-time validation and correction of processed data. This interactive component allows users to adjust bounding boxes, modify column mappings, and add or remove rows as needed, while maintaining the efficiency gains of automated processing. Furthermore, the teachings provided herein maintain a database of known vendors and items, using this information to validate and auto-populate fields when matches are found, reducing the likelihood of errors in the final processed invoice.

The methods and system that follow include the ability to learn and improve over time. The methods and system store both the initial algorithm output and any subsequent user corrections, creating a foundation for continuous improvement of the classification and recognition processes. This learning capability is specifically designed to adapt to real-world usage patterns, with heuristics being automatically adjusted based on accumulated data and user interactions. The teachings that follow also enable the automatic refinement of classification thresholds and recognition parameters as more invoices are processed through the system.

The embodiments described herein provide several technical advantages over conventional invoice processing techniques. As evidenced during testing, the methods and system that follow provide meaningful time savings compared to manual invoice entry, even when processing invoices with complex layouts or minor recognition issues. The efficiency gains are particularly notable when processing invoices with properly formatted data, where the methods and systems that follow can complete the processing in seconds. Thus, the methods and system according to embodiments of the technology disclosed herein provide efficiency gains that are not achievable by a manual process, thereby freeing up computing resources for other tasks.

A significant technical advantage of the multi-algorithm OCR teachings provided herein is the ability to optimize text recognition based on specific use cases. For example, when processing header rows, algorithms are executed that are specifically optimized for cell-level recognition, while different algorithms are employed for processing entire documents that are better suited for that task. This specialized approach provides a technical solution in the form of improved accuracy compared to single-algorithm solutions.

Furthermore, an interactive review process provides unique advantages by enabling users to maintain control over data accuracy while still benefiting from automation. Users can quickly verify detected columns, adjust boundaries, and modify mappings through an intuitive interface, significantly reducing the time required for invoice processing compared to manual entry. The methods and system that follow provide an ability to save progress during review to enable flexible workflows, allowing users to begin processing on mobile devices and complete the review later on desktop systems.

Moreover, the framework's learning capabilities provide continuous technical improvement benefits that conventional systems lack. By storing both initial algorithm outputs and user corrections, the methods and system that follow can automatically refine its classification thresholds and recognition parameters over time. For example, length thresholds are adjustable for distinguishing between item names and descriptions based on accumulated real-world usage data.

Still further, the methods and system that follow provide for integration with existing vendor and item databases to provide additional efficiency advantages. When an item identifier (ID) is recognized, related metadata is automatically populated from the database, reducing the need for manual data entry while ensuring higher accuracy than relying solely on OCR-extracted data. This database integration also enables validation of recognized vendor names against known vendors, improving the overall reliability of the processed invoice data.

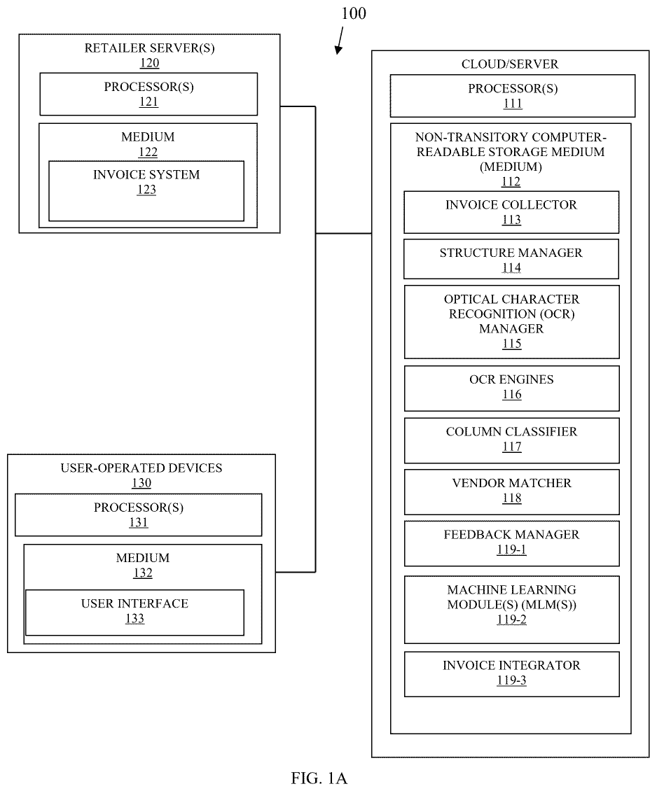

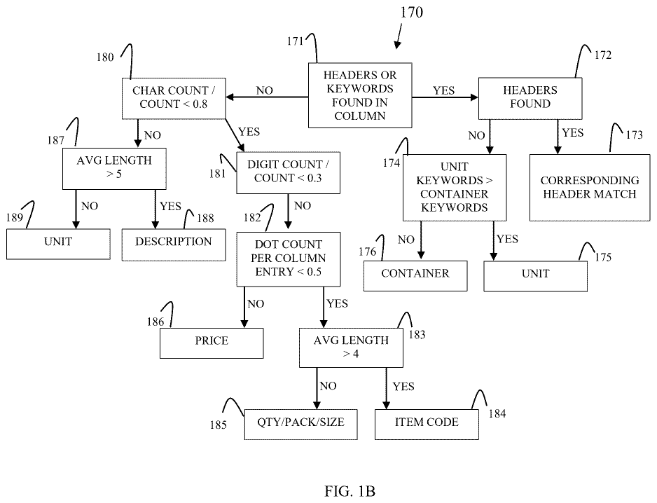

FIG. 1A is a diagram of a system 100 for performing machine-learning enhanced invoice data extraction, according to an example embodiment. Notably, the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of performing machine-learning enhanced invoice data extraction, presented herein and below.

System 100 includes a cloud 110 or server, one or more retailer servers 120, and one or more user-operated devices 130. Cloud 110 includes at least one processor 111 and a non-transitory computer-readable storage medium 112 (medium), which includes instructions for a invoice collector 113, a structure manager 114, a optical character recognition (OCR) manager 115, OCR engines or algorithms 116, a column classifier 117, a vendor matcher 118, a feedback manager 119-1, one or more optional machine learning models (MLM(s)), and an invoice integrator 119-3. The instructions when executed by the processor 111 cause the processor 111 to perform operations discussed herein and below with respect to 113-119-3.

Each retail server 120 includes at least one processor 121 and a medium 122, which includes instructions for an invoice system 123. The instructions when executed by the processor 121 cause the processor 121 to perform the operations discussed herein and below with respect to invoice system 123.

Each user-operated device 130 includes at least one processor 131 and a medium 132, which includes instructions for an interactive user interface 133. The instructions when executed by the processor 131 cause the processor 131 to perform operations discussed herein and below with respect to interactive user interface 133.

Invoice collector 113 receives invoices via user-operated device 130 from user interface 133. The invoices may be sent as digital invoices or as images taken from a camera either integrated into the user-operated device 130 in the case of a mobile device or interfaced to the user-operated device in the case of a laptop, desktop, etc.

When a digital invoice is provided, invoice collector 113 converts that digital invoice into an image format. The Invoice collector 113 then performs optical enhancement on the invoice image for skew correction and contrast correction to produce a modified and enhanced invoice image.

Next, structure manager 114 determines whether the enhanced invoice image is a bordered table by line detection in the enhanced image. When the enhanced invoice image depicts a bordered table, the structure manager 114 extracts the lines of the border table to identify the cells of the table depicted within the enhanced invoice image.

When the enhanced invoice image does not depict a bordered table, the structure manager 114 processes multiple OCR engines 116 against the enhanced invoice image to obtain text position data and bounding box coordinates. Different OCR algorithms are selected based on whether processing individual cells or full document sections. The overlapping bounding boxes along with text position data permit table structure identification.

The structure manager 114 is also capable of handling multiple tables that may appear in a single invoice image. In some cases, multiple tables in the invoice may be initially detected as a single table, with the target table being the second or subsequent table in the sequence. When this occurs, the header row for the target table may appear in the middle of what is detected as a single large table. The structure manager 114 analyzes the text patterns and positioning to properly identify and separate the distinct tables within the invoice image.

Once the table is identified in the enhanced invoice image, the column classifier 117 is processed for purposes of classifying the columns in the table. The column classifier's processing logic is illustrated and discussed below with reference to FIG. 1B.

Once the column classifier 117 has classified the columns and identified the individual elements of the table, the OCR manager 115 selects optimal OCR engines 116 for different elements. For header rows, a specialized cell-level OCR engine is used, while different algorithms are employed for processing full document sections. The OCR manager 115 may process multiple OCR engines 116 against the same element, with each engine returning confidence scores to allow selection of the most accurate result.

Using the OCR text and characters selected by OCR manager 115, vendor matcher 118 attempts a closest match against database records of a vendor data store to identify vendor names, vendor identifiers, and/or vendor-specific information associated with a particular vendor in the database for which the invoice is associated. When a match is found, corresponding metadata for the matched vendor and corresponding information permits vendor matcher 118 to assign the metadata to the invoice. The metadata may include unit of measurement and other vendor-assigned static information. The metadata retrieved from the database is prioritized over OCR-extracted data for known items identified on the invoice.

Once, the structure, elements, OCR for text and characters, and any metadata is assigned to the invoice, the feedback manager 119-1 presents the information in the interactive interface 133 to a user. The user is provided visual indications for detected table boundaries, column boundaries and column classifications, bounding boxes around recognized text elements, and confidence scores for the recognized elements provided by OCR engines 115. The user is also provided the recognized data for extracted text and its mapped classifications, column type assignments, and vendor and item matches from the database. The user is permitted, via interactive interface 133, to modify the presented visual indicators and recognized data by making bounding box adjustments including resizing existing boxes, deleting boxes, drawing new bounding boxes, and/or adjusting the boundaries of existing boxes. The user is also permitted to make classification changes including remapping column classifications (e.g., changing from a name to a description), correct misidentified column types, and reassigning column mappings. The bounding boxes and recognized data in the interface are visually overlayed onto the preprocessed images for the user to view the complete context of the invoice being presented within the interface.

The user can also save a partial progress of the user's editing session with the interactive interface during a user review of the invoice. The user can subsequently pick up the in-progress editing session via a different user-operated device 130 from an initial user-operated device 130 that the user originally initiated the session. Thus, the user can user interactive interface 133 to exit and return to continuing editing a given invoice.

Furthermore, the user can interact with interactive interface 133 to correct misread text, update vendor information, modify item metadata, and edit individual places where data has been missed by the OCR engines 116. The uses is in complete control over the accuracy of the invoice. The user can insert data and not just adjust something. Thus, the user can insert an additional row and/or add new or existing items manually during an editing session or a resumed editing session.

Feedback manager 119-1 also saves the outputs produced by the structure manager 114, OCR manager 115, OCR engines 116, column classifier 117, and vendor matcher 118 along with the invoice image and the user's edits during the user's finished editing session with interactive interface 133. This permits system 100 to use one or more MLMs 119-2 to adjust thresholds, processing parameters, and logic for continuous improvement, learning, and accuracy of structure manager 114, OCR manager 115, OCR engines 116, column classifier 117, and vendor matcher 118.

The MLMs 119-2 can include various types of models such as: Support Vector Machines (SVM) for column classification based on text characteristics; Random Forest classifiers to handle multiple classification features; Neural Networks for learning complex relationships between text features and column types; and Q-Learning algorithms to optimize the processing pipeline based on user correction patterns. Additionally, the MLMs 119-2 employ Ensemble Learning methods to dynamically combine outputs from multiple OCR algorithms with weighted scoring based on historical performance. The MLMs 119-2 also include Convolutional Neural Networks (CNN) for learning spatial patterns in invoice layouts and Recurrent Neural Networks (RNN) for sequence learning in item descriptions and codes. The transformer MLM architecture can also be used for both spatial and text analysis of the invoice These models continuously refine the classification thresholds and parameters as more production data becomes available.

Once a session is ended by a user and the details for the invoice are known, invoice integrator 119-3 sends the invoice for processing to a given invoice system 123 of a retailer associated with a given retail server 120. An application programming interface can be used to provide the completed invoice information and details to the invoice system 123 such that the process is completely automated.

FIG. 1B is a flow diagram of a method 170 for classifying column types, according to an example embodiment. FIG. 1B illustrates a column classifier for classifying columns detected within an invoice document. The column classification illustrated in method 170 is the column classifier 117 discussed above in FIG. 1A of system 100.

The column classifier begins at node 171 by evaluating whether headers or keywords are found in the column. If headers are found, the column classifier proceeds to node 172 where the column classifier determines if a corresponding header match exists at node 173. If no match is found, column classifier at node 174 performs an evaluation to check whether unit keywords are greater than container keywords. When the evaluation is no, a container column classification is identified at node 176, and when the evaluation at node 174 is yes, a unit column classification is found at node 175.

The column classifier includes multiple analysis paths based on various text characteristics. When headers or keywords are not found at node 171, the column classifier, at node 180, evaluates whether the ratio of character count to total count is less than 0.8. In parallel, at node 181, the column classifier analyzes whether the digit count to total count ratio is less than 0.3.

When the digit count to total count ratio is less than 0.3, the column classifier at node 182 checks to see if the frequency of decimal points (i.e., dot count per column entry) is less than 0.5. This analysis helps distinguish between price fields and other numeric fields like quantities or item codes. When the answer to evaluation of node 182 is yes, the column classifier checks to see if the average text length is greater than 4 and when it is an item code column classification is assigned at node 184. When the average text length is less than or equal to 4, the column classifier assigns a quantity/pack/size column classification at node 185. For columns containing potential unit information, the column classifier flows through node 173, where the column classifier evaluates if the average length is greater than 5. The column classifier then proceeds to node 174, which compares unit keywords against container keywords to determine proper column classification.

When the column classifier determines at node 180 that the ratio of character count to total count is greater than or equal to 0.8, the column classifier checks at node 187 to determine whether the average text length is greater than 5. When the average text length is greater than 5, the column classifier assigns a description column classification at node 188. When the average text length is less than or equal to 5, the column classifier assigns a unit column classification at node 189.

The column classification outcomes are represented by terminal nodes 175-176, 184, 185, 186, 188, and 189, which designate specific column types. These include a container column (176), unit column (175 and 189), a description column (188), a price column (186), quantity/pack/size column (185), and an item code column (184). The column classifier reaches these column classifications through various combinations of the analytical steps.

The decision tree reflected in FIG. 1B for the column classifier incorporates multiple validation checks, including evaluation of dot or decimal count per column entry at node 182 to distinguish price fields (186), and analysis of average decimal length at node 183 to differentiate between various field types (184 and 185). This structured approach enables accurate classification of invoice column elements while maintaining flexibility for system learning and improvement.

The classification parameters include specific thresholds such as: character count to total count ratio of 0.8, digit count to total count ratio of 0.3, dot count per column entry of 0.5, and average text length thresholds of 4 and 5 characters. These thresholds are automatically adjusted by the machine learning models based on accumulated user corrections and real-world usage patterns.

The classification parameters represented in FIG. 1B are designed to work in conjunction with the system's machine learning capabilities, allowing for refinement of thresholds and decision paths based on accumulated user corrections and feedback.

The system 100 is specifically designed to improve its performance over time as more production data becomes available. The feedback manager 119-1 connects all user interactions with the applications and stores them for analysis. By examining what the system 100 got wrong through user corrections, the MLMs 119-2 can feed this information back into the algorithms to continuously improve accuracy. This learning process is particularly important for refining the classification parameters and thresholds as real-world usage patterns emerge through actual invoice processing.

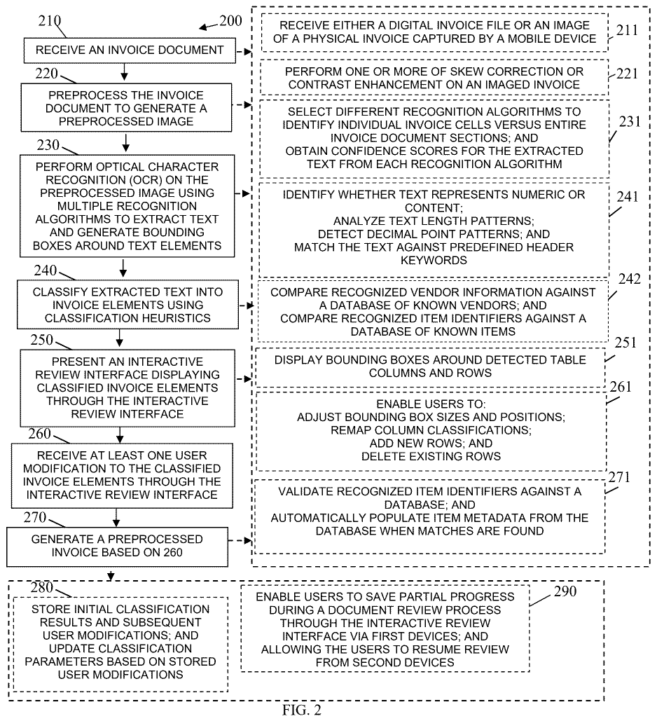

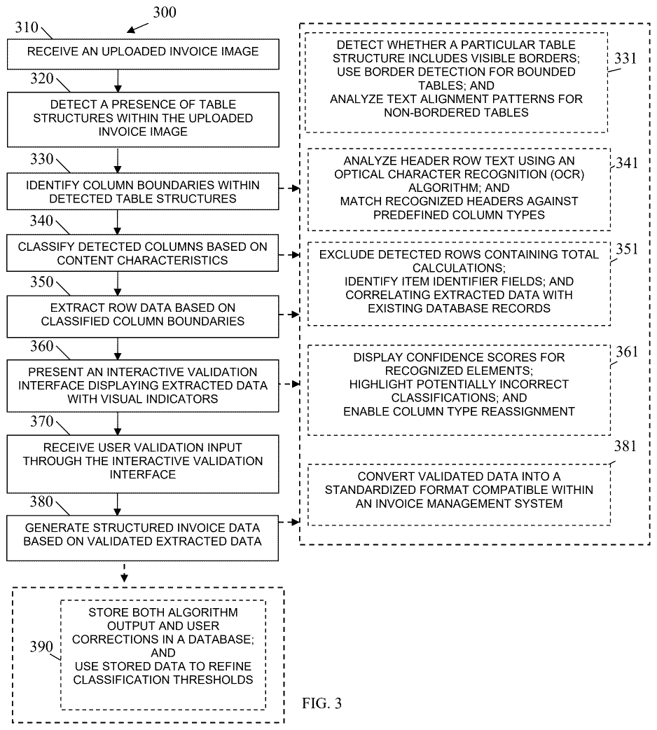

The above-referenced embodiments and other embodiments are now discussed within FIGS. 2-3. FIG. 2 is a flow diagram of a method 200 for performing machine-learning enhanced invoice data extraction, according to an example embodiment. The software module(s) that implements the method 200 is referred to as an “invoice manager.” The invoice manager is implemented as executable instructions programmed and residing within memory and/or a non-transitory computer-readable (processor-readable) storage medium and executed by one or more processors of one or more devices. The processor(s) of the device that executes the invoice manager are specifically configured and programmed to process the invoice manager. The invoice manager may have access to one or more network connections during its processing. The network connections can be wired, wireless, or a combination of wired and wireless.

In an embodiment, the device that executes the invoice manager is cloud 110. In an embodiment, the device that execute the invoice manager is retailer server 120. In an embodiment, the invoice manager is all or some combination of invoice collector 113, structure manager 114, OCR manager 115, OCR engines, 116, column classifier 117, vendor matcher 118, feedback manager 119-1, MLM(s) 119-2, and/or invoice integrator 119-3.

At 210, the invoice manager receives an invoice document. In an embodiment, at 211, the invoice manager receives the invoice document either as a digital invoice file or an image of a physical invoice captured by a mobile device or a scanner or camera interfaced to any user-operated device 130.

At 220, the invoice manager preprocesses the invoice document to generate a preprocessed image of the digital invoice. In an embodiment, at 221, the invoice manager performs one or more of skew correction or contrast enhancement on the imaged invoice.

At 230, the invoice manager performs OCR on the preprocessed image using multiple recognition algorithms, such as OCR engines 116, to extract text and generate bounding boxes around text elements. In an embodiment, at 231, the invoice manager selects different recognition algorithms to identify individual invoice cells versus entire invoice document sections. The invoice manager also obtains confidence scores for the extracted text from each recognition algorithm.

At 240, the invoice manager classifies extracted text into invoice elements using classification heuristics. In an embodiment, at 241, the invoice manager identifies whether text represents numeric or content and analyzes text length patterns. The invoice manager also matches the text against predefined header keywords. In an embodiment, at 242, the invoice manager compares recognized vendor information against a database of known vendors and compares recognized item identifiers against a database of known items. The invoice manager analyzes frequency of decimal points within text entries to distinguish between price fields and other numeric fields, using a threshold of 0.5 for dot count per column entry.

At 250, the invoice manager presents an interactive review interface that displayed classified invoice elements through the interactive review interface. In an embodiment, at 251, the invoice manager displays bounding boxes around detected table columns and rows.

At 260, the invoice manager receives at least one user modification to the classified invoice elements through the interactive interface. In an embodiment, at 261, the invoice manager enables users to adjust bounding box sizes and positions, remap column classifications, add new rows, and delete existing rows through the interactive review interface.

At 270, the invoice manager generates a preprocessed invoice based on at least 260. In an embodiment, at 271, the invoice manager validates recognized item identifiers against a database and automatically populates item metadata from the database when matches are found.

In an embodiment, at 280, the invoice manager stores initial classification results and subsequent user modifications. The invoice manager also updates classification parameters based on stored user modifications.

In an embodiment, at 290, the invoice manager enables users to save partial process during a document review process through the interactive revie interface view first devices. The invoice manager also allows the users to resume review from second and different devices.

FIG. 3 is a diagram of another method 300 for performing machine-learning enhanced invoice data extraction, according to an example embodiment. The software module(s) that implements the method 300 is referred to as an “automated invoice manager.” The automated invoice manager is implemented as executable instructions programmed and residing within memory and/or a non-transitory computer-readable (processor-readable) storage medium and executed by one or more processors of a device. The processors that execute the automated invoice manager are specifically configured and programmed for processing the automated invoice manager. The automated invoice manager may have access to one or more network connections during its processing. The network connections can be wired, wireless, or a combination of wired and wireless.

In an embodiment, the device that executes the automated invoice manager is cloud 110. In an embodiment, the device that execute the automated invoice manager is retailer server 120. In an embodiment, the automated invoice manager is all or some combination of invoice collector 113, structure manager 114, OCR manager 115, OCR engines, 116, column classifier 117, vendor matcher 118, feedback manager 119-1, MLM(s) 119-2, invoice integrator 119-3, and/or method 200 of FIG. 2.

At 310, the automated invoice manager receives an uploaded invoice image. At 320, the automated invoice manager detects a presence of table structures within the uploaded invoice image.

At 330, the automated invoice manager identifies column boundaries within detected table structures. In an embodiment, at 331, the automated invoice manager detects whether a particular table structure includes visible borders, uses border detection for bounded tables, and analyzes text alignment patterns for non-bounded tables.

At 340, the automated invoice manager classifies detected columns based on content characteristics. In an embodiment, at 341, the automated invoice manager analyzes header row text using an OCR algorithm or engine and matches recognized headers against predefined column types.

At 350, the automated invoice manager extracts row data based on classified column boundaries. In an embodiment, at 351 automated invoice manager excludes detected rows containing total calculations, identifies item identifier fields, and correlates extracted data with existing database records. The automated invoice manager identifies and excludes rows containing total calculations to prevent duplicate data entry, while maintaining the structural integrity of the invoice data.

At 360, the automated invoice manager presents an interactive validation interface that displays extracted data with visual indicators. In an embodiment, at 361, the automated invoice manager displays confidence scores for recognized elements, highlights potentially incorrect classifications, and enables column type reassignment through the interactive validation interface.

At 370, the automated invoice manager receives user validation input through the interactive validation interface. This indicates the user is done editing the invoice or approves of the automatically generated invoice.

At 380, the automated invoice manager generates structured invoice data based on validated extracted data. In an embodiment, at 381, the automated invoice manager converts validated data into a standardized format compatible within an invoice management system and provides the invoice to the invoice management system.

In an embodiment, at 390, the automated invoice manager stores both algorithm output and user corrections in a database. The automated invoice manager also uses stored data to refine classification threshold for subsequent automated invoice processing.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving an invoice document;
preprocessing the invoice document to generate a preprocessed image;
performing optical character recognition (OCR) on the preprocessed image using multiple recognition algorithms to extract text and generate bounding boxes around text elements;
classifying extracted text into invoice elements using classification heuristics;
presenting an interactive review interface displaying classified invoice elements with visual annotations;
receiving at least one user modification to the classified invoice elements through the interactive review interface; and
generating a processed invoice based on at least one user-modified classified invoice element.

2. The method of claim 1, wherein receiving the invoice document comprises receiving either a digital invoice file or an image of a physical invoice captured by a mobile device.

3. The method of claim 1, wherein preprocessing the invoice document comprises performing one or more of: skew correction or contrast enhancement on an imaged invoice.

4. The method of claim 1, wherein performing the OCR comprises:
selecting different recognition algorithms to identify individual cells versus entire invoice document sections; and
obtaining confidence scores for the extracted text from each recognition algorithm.

5. The method of claim 1, wherein classifying the extracted text comprises:
identifying whether text represents numeric or content;
analyzing text length patterns;
detecting decimal point patterns; and
matching the text against predefined header keywords.

6. The method of claim 1, wherein classifying the extracted text comprises:
comparing recognized vendor information against a database of known vendors; and
comparing recognized item identifiers against a database of known items.

7. The method of claim 1, wherein presenting the interactive review interface comprises displaying bounding boxes around detected table columns and rows.

8. The method of claim 1, wherein receiving the at least one user modification comprises enabling users to:
adjust bounding box sizes and positions;
remap column classifications;
add new rows; and
delete existing rows.

9. The method of claim 1, wherein generating the processed invoice comprises:
validating recognized item identifiers against a database; and
automatically populating item metadata from the database when matches are found.

10. The method of claim 1, further comprising:
storing initial classification results and subsequent user modifications; and
updating classification parameters based on stored user modifications.

11. The method of claim 1, further comprising:
enabling users to save partial progress during a document review process through the interactive review interface via first devices; and
allowing the users to resume review from second devices.

12. A method, comprising:
receiving an uploaded invoice image;
detecting a presence of table structures within the uploaded invoice image;
identifying column boundaries within detected table structures;
classifying detected columns based on content characteristics;
extracting row data based on classified column boundaries;
presenting an interactive validation interface displaying extracted data with visual indicators;
receiving user validation input through the interactive validation interface; and
generating structured invoice data based on validated extracted data.

13. The method of claim 12, wherein identifying the column boundaries comprises:
detecting whether a particular table structure includes visible borders;
using border detection for bordered tables; and
analyzing text alignment patterns for non-bordered tables.

14. The method of claim 12, wherein classifying the detected columns comprises:
analyzing header row text using an optical character recognition (OCR) algorithm; and
matching recognized headers against predefined column types.

15. The method of claim 12, wherein extracting the row data comprises:
excluding detected rows containing total calculations;
identifying item identifier fields; and
correlating extracted data with existing database records.

16. The method of claim 12, wherein presenting the interactive validation interface comprises:
displaying confidence scores for recognized elements;
highlighting potentially incorrect classifications; and
enabling column type reassignment.

17. The method of claim 12, wherein generating the structured invoice data comprises converting validated data into a standardized format compatible with an invoice management system.

18. The method of claim 12, further comprising:
storing both algorithm output and user corrections in a database; and
using stored data to refine classification thresholds.

19. A system, comprising:
at least one processor; and
a memory storing instructions that, when executed by the at least one processor, cause the system to:
receive invoice documents through multiple input channels;
preprocess received documents using image enhancement techniques;
perform text recognition using multiple specialized optical character recognition algorithms;
classify recognized text using configurable heuristics and machine learning;
present an interactive review interface;
store user modifications for system learning; and
generate standardized invoice data.

20. The system of claim 19, wherein the memory stores additional instructions that cause the system to:
maintain a database of vendor information and item data;
compare recognized elements against the database;
automatically populate matched item metadata; and
update classification parameters based on accumulated user corrections.
